(19) United States
(12) Patent Application Publication
(10) Pub. No.: US 2026/0129337 A1
(43) Pub. Date: May 7, 2026

(54) EARPHONES

(71) Applicant: SHENZHEN SHOKZ CO., LTD., Shenzhen (CN)

(72) Inventors: Chu WANG, Shenzhen (CN); Jianhua XIE, Shenzhen (CN)

(73) Assignee: SHENZHEN SHOKZ CO., LTD., Shenzhen (CN)

(21) Appl. No.: 19/433,941

(22) Filed: Dec. 28, 2025

Related U.S. Application Data
(63) Continuation of application No. PCT/CN2024/096717, filed on May 31, 2024.

(51) Int. Cl. H04R 1/10

(52) U.S. Cl. CPC H04R 1/1041; H04R 1/1016; H04R 1/105; H04R 1/1075

(57) ABSTRACT

The present disclosure provides an earphone. The earphone includes a first housing, a first touch detection element, a second touch detection element, and a processing circuit. The first housing has a first touch region and a second touch region that are spaced apart from each other and arranged back-to-back in orientation. The first touch detection element is configured to generate a first touch indication signal in response to a capacitance change caused by a touch operation of a user on the first touch region. The second touch detection element is configured to generate a second touch indication signal in response to a capacitance change caused by a touch operation of the user on the second touch region. The processing circuit is configured to generate a control instruction based on the first touch indication signal, the second touch indication signal, and a preset instruction generation logic.

### CROSS-REFERENCE TO RELATED APPLICATIONS

This application is a continuation of International Patent Application No. PCT/CN2024/096717, filed on May 31, 2024, the contents of which are hereby incorporated by reference.

### TECHNICAL FIELD

The present disclosure relates to the field of electronic devices, and in particular, to an earphone.

### BACKGROUND

With the continuous popularization of electronic devices, electronic devices have become indispensable social and entertainment tools in people's daily lives, and people's requirements for electronic devices are also increasing. Earphones, as such electronic devices, have been widely used in people's daily lives. They are used in conjunction with terminal devices such as mobile phones and computers to provide users with an auditory feast. According to the working principle of earphones, earphones can generally be classified into air conduction earphones and bone conduction earphones; according to the way users wear earphones, earphones can generally be classified into over-ear earphones, ear-clip earphones, and in-ear earphones; and according to the interaction manner between earphones and electronic devices, earphones can also be classified into wired earphones and wireless earphones.

However, current ear-clip earphones are prone to false touches by users during use, making it difficult to meet usage requirements.

### SUMMARY

Some embodiments of the present disclosure provide an earphone. The earphone includes a first housing, a first touch detection element, a second touch detection element, and a processing circuit. The first housing carries the first touch detection element and the second touch detection element, and has a first touch region and a second touch region that are spaced apart from each other and arranged back-to-back in orientation. The first touch detection element is configured to generate a first touch indication signal in response to a capacitance change caused by a touch operation of a user on the first touch region. The second touch detection element is configured to generate a second touch indication signal in response to a capacitance change caused by a touch operation of the user on the second touch region. The processing circuit is configured to generate a control instruction based on the first touch indication signal, the second touch indication signal, and a preset instruction generation logic.

In some embodiments, in a wearing state of the earphone, the first housing is located on a back side of a helix of the user, and a spacing direction between the first touch region and the second touch region is arranged to intersect with a horizontal plane of the user.

In some embodiments, the preset instruction generation logic is configured to generate a first control instruction in response to the first touch indication signal and the second touch indication signal, respectively indicating that the user is continuously contacting the first touch region and the second touch region.

In some embodiments, the preset instruction generation logic is configured to generate a second control instruction in response to the first touch indication signal indicating that the user continuously contacts the first touch region, while the second touch indication signal indicates that the user is tapping the second touch region.

In some embodiments, the preset instruction generation logic is configured to generate a third control instruction in response to the first touch indication signal and the second touch indication signal, respectively indicating that the user is tapping the first touch region and tapping the second touch region.

In some embodiments, the earphone further includes a wearing detection element. The wearing detection element is configured to detect whether the earphone is in a wearing state or a non-wearing state. The processing circuit is configured to select different preset instruction generation logics when the earphone is in the wearing state or the non-wearing state, such that identical first touch indication signals and identical second touch indication signals produce different control signals through the different preset instruction generation logics.

In some embodiments, the earphone further includes a left-right ear detection element. The left-right ear detection element is configured to detect whether the earphone is worn on a left ear or a right ear. The processing circuit is configured to select different preset instruction generation logics when the earphone is worn on the left ear or the right ear, such that identical first touch indication signals and identical second touch indication signals produce different control signals through the different

preset instruction generation logics.

In some embodiments, the left-right ear detection element is a gravity sensor. The earphone further includes a wearing detection element configured to detect whether the earphone is in a wearing state or a non-wearing state. The processing circuit is configured to trigger a detection function of the left-right ear detection element when the earphone is in the wearing state.

In some embodiments, the first touch detection element and the second touch detection element are respectively arranged in a sheet-shape. The earphone further includes a battery disposed in the first housing, the battery being arranged in a column shape. The first touch detection element and the second touch detection element are spaced apart along an axial direction of the battery and disposed at two ends of the battery, and at least a portion of a projection of the first touch detection element along the axial direction of the battery and at least a portion of a projection of the second touch detection element along the axial direction of the battery overlap with an end face of the battery, respectively.

In some embodiments, a ratio of an overlapping area between the first touch detection element and the end face of the battery to an area of a main surface of the first touch detection element is greater than or equal to 0.9; a ratio of an overlapping area between the second touch detection element and the end face of the battery to an area of a main surface of the second touch detection element is greater than or equal to 0.9; an angle between a normal direction of the main surface of the first touch detection element and the axial direction of the battery is less than or equal to 10°, and an angle between a normal direction of the main surface of the second touch detection element and the axial direction of the battery is less than or equal to 10°.

In some embodiments, the earphone further includes a second housing, a connecting component, and a sounding assembly. The sounding assembly is disposed in the second housing. The connecting component connects the first housing and the second housing. In a wearing state of the earphone, the first housing and the second housing form a clamping fit on two sides of the helix, and the second housing is located in a cavum concha. The connecting component has a symmetry plane arranged along a length direction of the connecting component. The axial direction of the battery is arranged to intersect with the symmetry plane.

In some embodiments, the symmetry plane intersects with a sagittal plane of the user, and an angle between the symmetry plane and the sagittal plane is greater than or equal to 72° and less than or equal to 90°.

The beneficial effect of the present disclosure is as follows: by configuring the processing circuit to generate the control instruction based on the first touch indication signal indicating the user's touch operation on the first touch region and the second touch indication signal indicating the user's touch operation on the second touch region, and according to the preset instruction generation logic, to correspondingly control the earphone, it effectively prevents false touches of the earphone, effectively improves the accuracy of the earphone in detecting the user's touch operations, effectively improves the control accuracy of the earphone, and is conducive to enriching the interactive functions of the earphone, enhancing the applicability of the earphone.

### BRIEF DESCRIPTION OF THE DRAWINGS

FIG. 1 is a schematic diagram illustrating a wearing state of an earphone worn on a human ear according to some embodiments of the present disclosure;

FIG. 2 is a schematic diagram illustrating an exemplary stereoscopic structure of an earphone shown in FIG. 1;

FIG. 3 is a schematic diagram illustrating a top view of an exemplary structure of an earphone shown in FIG. 1;

FIG. 4 is a schematic diagram illustrating another exemplary stereoscopic structure of an earphone shown in FIG. 1;

FIG. 5 is a schematic block diagram illustrating a circuit structure of the embodiment of an earphone shown in FIG. 1;

FIG. 6 is a schematic diagram illustrating an exemplary stereoscopic structure of a part of an earphone shown in FIG. 1; and

FIG. 7 is a schematic diagram illustrating an exemplary exploded structure of a part of an earphone shown in FIG. 1.

### DETAILED DESCRIPTION

The following will describe in detail the embodiments of the technical solutions of the present disclosure with reference to the accompanying drawings. The following embodiments are only used to illustrate the technical solutions of the present disclosure more clearly, and are therefore only examples, and should not be used to limit the protection scope of the present disclosure.

In the present disclosure, mentioning "embodiment" means that specific features, structures, or characteristics described in combination with the embodiment may be included in at least one embodiment of the present disclosure. Those skilled in the art explicitly and implicitly understand that the embodiments described in the present disclosure may be combined with other embodiments.

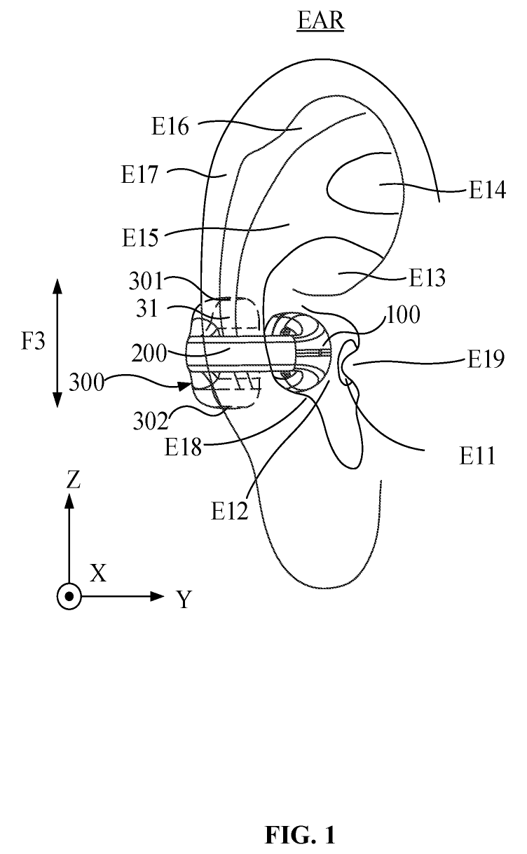

As shown in FIG. 1, an ear EAR of a user may include physiological parts such as an external ear canal E11, a cavum concha E12, a cymba concha E13, a triangular fossa E14, an antihelix E15, a scapha E16, a helix E17, and an antitragus E18. Although the external ear canal E11 has a certain depth and extends to an eardrum of the ear EAR, for ease of description and in combination with FIG. 1, in the present disclosure, unless otherwise specified, the external ear canal E11 specifically refers to its entrance away from the eardrum (i.e., an ear hole). Furthermore, the physiological parts such as the cavum concha E12, the cymba concha E13, and the triangular fossa E14 have a certain volume and depth; and the cavum concha E12 is directly connected to the external ear canal E11, that is, it may be simply considered that the ear hole is located at a bottom of the cavum concha E12.

Furthermore, around the external ear canal of the ear EAR, there is also a tragus E19. Compared to the physiological parts such as the cavum concha E12, the cymba concha E13, and the triangular fossa E14, which have the certain volume and depth in three-dimensional space, that is, these physiological parts are recessed toward a rear side of the ear EAR along a direction toward the user's head, and the tragus E19 protrudes toward a front side of the ear EAR along a direction away from the user's head. "The front side of the ear EAR" is a concept relative to "the rear side of the ear EAR,” where the former refers to a side of the ear EAR away from the head, as shown in FIG. 1, and the latter refers to a side of the ear EAR toward the head, both of which are for the ear EAR of the user.

Furthermore, different users may have individual differences, leading to variations in the shape, size, and other dimensions of the ear EAR. To facilitate description and reduce (or even eliminate) individual differences among the users, unless otherwise specified, the present disclosure will mainly use an ear model with a standard shape and a standard size as a reference to further describe a wearing manner of an acoustic device in different embodiments on the ear model. For example, based on ANSI: S3.36, S3.25, and IEC: 603187 standards, a simulator including a head and its (left and right) ears EAR, such as GRAS 45BC KEMAR, may be manufactured as a reference for wearing the acoustic device, thereby presenting the scenario where most users normally wear the acoustic device. Merely by way of example, the reference ear EAR may have the following relevant characteristics: a size of a projection of the auricle on a sagittal plane in a vertical axis direction may be in a range of 49.5 mm to 74.3 mm, and a size of the projection of the auricle on the sagittal plane in a sagittal axis direction may be in a range of 36.6 mm to 55 mm. Therefore, in the present disclosure, descriptions such as "the user wears" and "in a wearing state" may refer to the acoustic device described in the present disclosure being worn on the ear EAR of the simulator. Of course, considering individual differences among users, the structure, shape, size, thickness, etc., of one or more parts of the ear EAR may vary. To meet the needs of different users, the acoustic device may be differentially designed, and differential designs may be reflected in that feature parameters of one or more structures of the acoustic device (for example, a sound generating component 100, a connecting component 200, etc., below) may have values in different ranges to adapt to different ears EAR.

It should be noted that in fields such as medicine and anatomy, three basic planes of the human body are defined: a sagittal plane, a coronal plane, and a horizontal plane, as well as three basic axes: a sagittal axis, a coronal axis, and a vertical axis. The sagittal plane refers to a plane perpendicular to the ground made along an anterior-posterior direction of the human body, which divides the human body into left and right parts. The coronal plane refers to a plane perpendicular to the ground made along a left-right direction of the human body, which divides the human body into anterior and posterior parts. The horizontal plane refers to a plane parallel to the ground made to divide the human body into upper and lower parts along a superior-inferior direction of the human body. Correspondingly, the sagittal axis refers to an axis along the anterior-posterior direction of the human body and perpendicular to the coronal plane. The coronal axis refers to an axis along the left-right direction of the human body and perpendicular to the sagittal plane. The vertical axis refers to an axis along the superior-inferior direction of the human body and perpendicular to the horizontal plane. Furthermore, "the front side of the ear EAR" described in the present disclosure is a concept relative to "the rear side of the ear EAR,” where the former refers to a side of the ear EAR away from the head, and the latter refers to the side of the ear EAR toward the head, both of which are for the ear EAR of the user. By observing the ear EAR of the aforementioned simulator along the direction of the coronal axis of the human body, a contour of the front side of the ear EAR as shown in FIG. 1 may be obtained. Based on this, combined with FIG. 1, the three directions X, Y, and Z may be simply regarded as the coronal axis, the sagittal axis, and the vertical axis of the human body, respectively; the three planes XY, XZ, and YZ may be simply regarded as the horizontal plane, the coronal plane, and the sagittal plane of the human body, respectively.

Referring to FIGS. 1, 2, and 3, the present disclosure provides an earphone 1, which is an ear-clip earphone 1. The earphone 1 includes a sound generating component 100 inserted into the cavum concha E12 of the user, an abutting component 300 for abutting the back of the user's ear, and a connecting component 200 connecting the sound generating component 100 and the abutting component 300. The sound generating component 100 is a sound playback device, which is used to convert electrical signals into sound signals and play them to the user. In the wearing state, the sound generating component 100 is located in the cavum concha E12. Specifically, the abutting component 300 and the sound generating component 100 form a clamping fit to respectively about a back of the ear and an inner wall of the cavum concha E12, to clamp and wear the entire earphone 1 on the user's ear EAR. In some embodiments, the abutting component 300 may be used as a battery compartment to install a battery 700 or other components. Of course, the abutting component 300 may not be used as a battery compartment, and the battery 700 may be installed in the sound generating component 100. The connecting component 200 is a component that provides a clamping force. Both ends of the connecting component 200 are connected to the sound generating component 100 and the abutting component 300, respectively. In the wearing state, the connecting component 200 bypasses the helix E17 so that the sound generating component 100 and the abutting component 300 are located on two sides of the ear EAR along the coronal axis of the human body, and the sound generating component 100 extends into the cavum concha E12 to transmit sound to the ear canal.

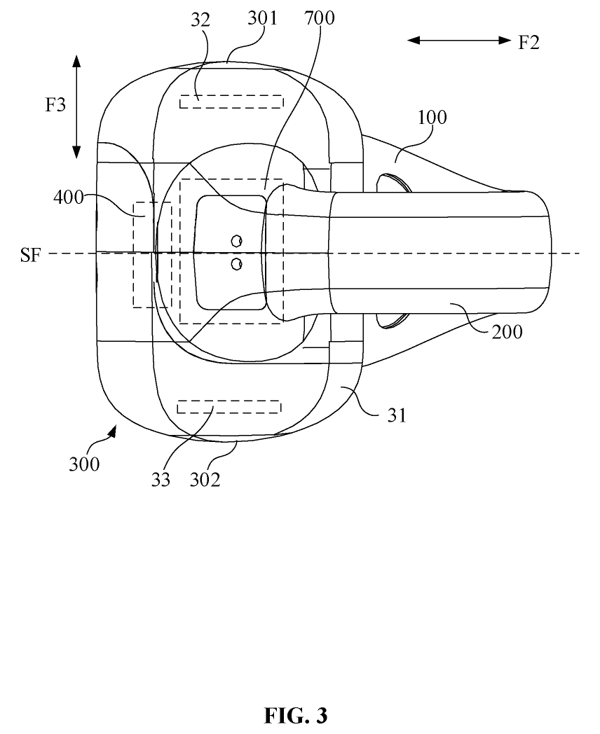

In some embodiments, as shown in FIG. 3, the earphone 1 includes a first housing 31, a first touch detection element 32, a second touch detection element 33, and a processing circuit 400. Optionally, the abutting component 300 includes the first housing 31, the first housing 31 carries the first touch detection element 32 and the second touch detection element 33, and the first housing 31 has a first touch region 301 and a second touch region 302 that are spaced apart from each other and arranged back-to-back in orientation. The first touch detection element 32 is configured to generate a first touch indication signal in response to a capacitance change caused by a touch operation of the user on the first touch region 301. The second touch detection element 33 is configured to generate a second touch indication signal in response to a capacitance change caused by a touch operation of the user on the second touch region 302.

The touch operation of the user may be, such as, simultaneously pressing the first touch region 301 and the second touch region 302, i.e., continuously contacting the first touch region 301 and the second touch region 302, or simultaneously tapping the first touch region 301 and the second touch region 302, or pressing one of the first touch region 301 and the second touch region 302 while simultaneously tapping the other. The processing circuit 400 may be a circuit board or a circuit board assembly, configured to generate a control instruction based on the first touch indication signal, the second touch indication signal, and a preset instruction generation logic. The control instruction may be used, such as to control the earphone 1 to stop or pause music playback, start music playback, switch to the next music in the playlist, switch to the previous music in the playlist, etc. The first touch detection element 32 and the second touch detection element 33 may be capacitive touch sensors or resistive touch sensors, and of course, may also be other touch detection elements.

By providing the first touch detection element 32 and the second touch detection element 33, and arranging the first touch region 301 and the second touch region 302 corresponding to the first touch detection element 32 and the second touch detection element 33 respectively on the first housing 31 in a spaced and back-to-back in orientation manner, the processing circuit 400 generates the control instruction according to the preset instruction generation logic based on the first touch indication signal indicating the user's touch on the first touch region 301 and the second touch indication signal indicating the user's touch on the second touch region 302, so as to correspondingly control the earphone 1, which can effectively prevent false touches of the earphone 1, effectively improve the accuracy of detecting the user's touch operation on the earphone 1, effectively improve the control accuracy of the earphone 1, effectively enrich the interactive functionality of the earphone 1, and improve the applicability of the earphone 1.

Optionally, as shown in FIG. 1, in the wearing state, the first housing 31 is located on a back side of the helix E17 of the user, and a spacing direction F3 between the first touch region 301 and the second touch region 302 is arranged to intersect with a horizontal plane of the user. Such an arrangement facilitates the user to perform touch operations on the first touch region 301 and the second touch region 302, thus enhancing the convenience and comfort of the touch experience.

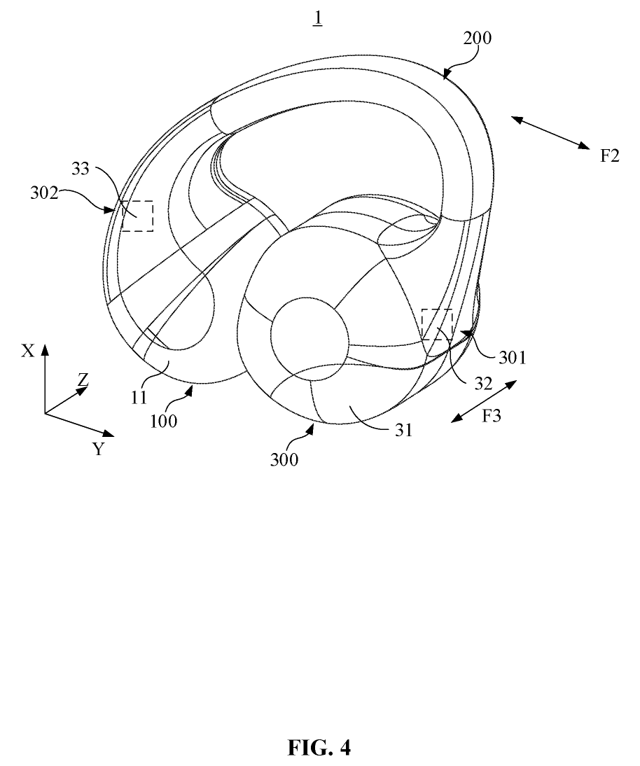

In some embodiments, as shown in FIG. 4, the abutting component 300 includes the first housing 31, the sound generating component 100 includes a second housing 11, the first housing 31 carries the first touch detection element 32, the second housing 11 carries the second touch detection element 33, and a side of the first housing 31 away from the helix E17 has the first touch region 301, a side of the second housing 11 away from the helix E17 has the second touch region 302; the first touch detection element 32 is configured to generate the first touch indication signal in response to a capacitance change caused by a touch operation of the user on the first touch region 301; the second touch detection element 33 is configured to generate the second touch indication signal in response to a capacitance change caused by a touch operation of the user on the second touch region 302; the processing circuit 400 is configured to generate the control instruction based on the first touch indication signal, the second touch indication signal, and the preset instruction generation logic.

By arranging the first touch region 301 and the second touch region 302 on the sides of the abutting component 300 and the sound generating component 100 away from the helix E17, respectively, mutual interference between the first touch region 301 and the second touch region 302 can be effectively avoided, and the user is facilitated to perform touch operations, effectively preventing false touches of the earphone 1 and effectively improving the accuracy of detecting the user's touch operation on the earphone 1.

The following exemplarily describes how the processing circuit 400 generates the control instruction based on the preset instruction generation logic.

In some embodiments, the preset instruction generation logic is configured to generate a first control instruction in response to the first touch indication signal and the second touch indication signal indicating that the user is continuously contacting the first touch region 301 and the second touch region 302, respectively. For example, when the user simultaneously presses the first touch region 301 and the second touch region 302, i.e., continuously contacting the first touch region 301 and the second touch region 302, the first touch detection element 32 and the second touch detection element 33 generate the first touch indication signal and the second touch indication signal respectively, and the processing circuit 400 generates the first control instruction based on the first touch indication signal, the second touch indication signal, and the preset instruction generation logic.

In some embodiments, the preset instruction generation logic is configured to generate a second control instruction in response to the first touch indication signal indicating that the user continuously contacts the first touch region 301, while the second touch indication signal indicates that the user is tapping the second touch region 302. For example, when the user presses the first touch region 301, i.e., continuously contacting the first touch region 301, and simultaneously taps the second touch region 302, the first touch detection element 32 and the second touch detection element 33 generate the first touch indication signal and the second touch indication signal respectively, and the processing circuit 400 generates the second control instruction based on the first touch indication signal, the second touch indication signal, and the preset instruction generation logic.

In some embodiments, the preset instruction generation logic is configured to generate a third control instruction in response to the first touch indication signal and the second touch indication signal indicating that the user is tapping the first touch region 301 and the second touch region 302, respectively. For example, when the user simultaneously taps the first touch region 301 and the second touch region 302, the first touch detection element 32 and the second touch detection element 33 generate the first touch indication signal and the second touch indication signal respectively, and the processing circuit 400 generates the third control instruction based on the first touch indication signal, the second touch indication signal, and the preset instruction generation logic.

Optionally, the first control instruction, the second control instruction, and the third control instruction may be configured to control the same function of the earphone 1, or may respectively control different functions of the earphone 1. For example, the first control instruction, the second control instruction, and the third control instruction are all configured to control the earphone 1 to play music, or to pause music playback when the earphone 1 is playing music. As another example, the first control instruction is configured to control turning on and off of the earphone 1, the second control instruction is configured to control music switching of the earphone 1, and the third control instruction is configured to control music playback and pausing of the earphone 1. Of course, the first control instruction, the second control instruction, and the third control instruction may also be configured to achieve other control functions, which is not limited in the present disclosure, and those skilled in the art may make selections according to actual needs.

By configuring the processing circuit 400 to generate the control instruction based on the first touch indication signal, the second touch indication signal, and the preset instruction generation logic, and when the user operations indicated by the first touch indication signal and the second touch indication signal are different, the generated control instructions are also different, it effectively prevents false touches while enriching the interactive functions of the earphone 1, allowing the user to achieve

diversified control of the earphone 1 only through touch and thereby improving the applicability of the earphone 1.

Optionally, the processing circuit 400 is configured to generate the control instruction based on the preset instruction generation logic when confirming that the first touch indication signal and the second touch indication signal are greater than a first threshold and a second threshold, respectively. By setting the first threshold and the second threshold, the user's touch operations on the first touch region 301 and the second touch region 302 are effectively monitored, effectively reducing the possibility of control errors caused by the user's false touches on the first touch region 301 and the second touch region 302, improving the accuracy of detecting the user's touch operation, and improving the control accuracy of the earphone 1.

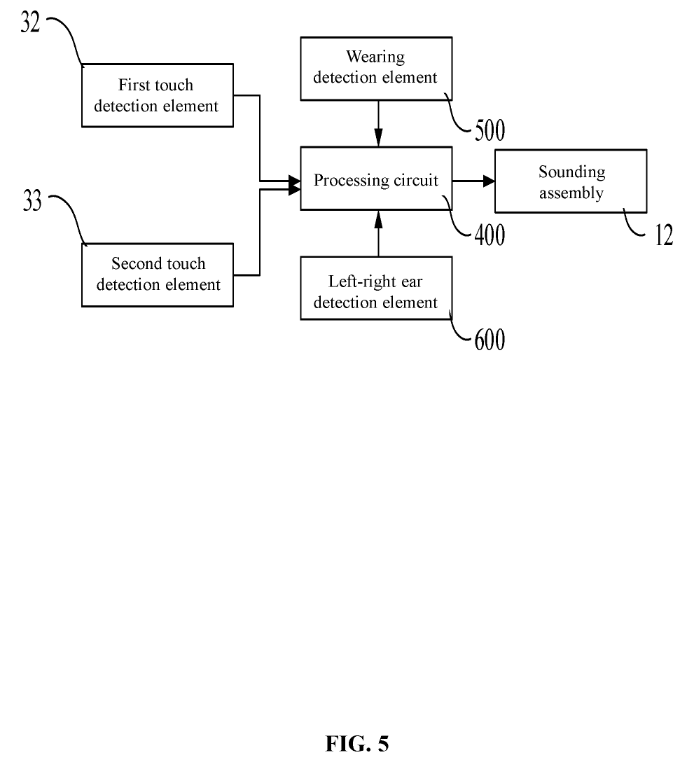

Optionally, as shown in FIG. 5, the earphone 1 further includes a wearing detection element 500. The wearing detection element 500 is configured to detect whether the earphone 1 is in a wearing state or a non-wearing state. The processing circuit 400 is configured to select different preset instruction generation logics when the earphone 1 is in the wearing state or the non-wearing state, such that identical first touch indication signals and identical second touch indication signals produce different control signals through the different preset instruction generation logics. For example, when the wearing detection element 500 detects that the earphone 1 is in the wearing state, if the first touch indication signal and the second touch indication signal respectively indicate that the user is continuously contacting the first touch region 301 and the second touch region 302, then the processing circuit 400 generates a control instruction to control the earphone 1 to pause music according to the preset instruction generation logic; and when the wearing detection element 500 detects that the earphone 1 is in the non-wearing state, if the first touch indication signal and the second touch indication signal respectively indicate that the user is continuously contacting the first touch region 301 and the second touch region 302, then the processing circuit 400 generates a control instruction to control the earphone 1 to turn off according to the preset instruction generation logic.

By providing the wearing detection element 500 and setting the preset instruction generation logic adapted to different wearing states, the interactive functions of the earphone 1 are enriched, providing the user with more diversified control mechanisms, and effectively enhancing the fun and convenience of using the earphone 1.

Optionally, as shown in FIG. 5, the earphone 1 further includes a left-right ear

detection element 600. The left-right ear detection element 600 is configured to detect whether the earphone 1 is worn on a left ear or a right ear. The processing circuit 400 is configured to select different preset instruction generation logics when the earphone 1 is worn on the left ear or the right ear, such that identical first touch indication signals and identical second touch indication signals produce different control signals through the different preset instruction generation logics. For example, when the left-right ear detection element 600 detects that the earphone 1 is worn on the left ear, if the first touch indication signal and the second touch indication signal respectively indicate that the user is tapping the first touch region 301 and the second touch region 302, then the processing circuit 400 generates a control instruction to control the earphone 1 to switch to the previous music in the playlist according to the preset instruction generation logic; and when the left-right ear detection element 600 detects that the earphone 1 is worn on the right ear, if the first touch indication signal and the second touch indication signal respectively indicate that the user is tapping the first touch region 301 and the second touch region 302, then the processing circuit 400 generates a control instruction to control the earphone 1 to switch to the next music in the playlist according to the preset instruction generation logic.

By providing the left-right ear detection element 600 and setting the preset instruction generation logics adapted to wearing on the left ear and the right ear respectively, diversified control of the earphone 1 is achieved, enriching the interactive functions of the earphone 1, and enhancing the fun and convenience of using the earphone 1.

Optionally, as shown in FIG. 5, the earphone 1 includes the wearing detection element 500 and the left-right ear detection element 600. The left-right ear detection element 600 is a gravity sensor. The wearing detection element 500 is configured to detect whether the earphone 1 is in the wearing state or the non-wearing state. The processing circuit 400 is configured to trigger a detection function of the left-right ear detection element 600 when the earphone 1 is in the wearing state.

By simultaneously providing the wearing detection element 500 and the left-right ear detection element 600, the detection of whether the earphone 1 is worn on the left ear or the right ear is further performed only when the user wears the earphone 1, and then the corresponding preset instruction generation logic is adopted, effectively reducing the possibility of false touches of the earphone 1 when it is placed in a pocket or on a table, etc., and further improving the control accuracy of the earphone 1.

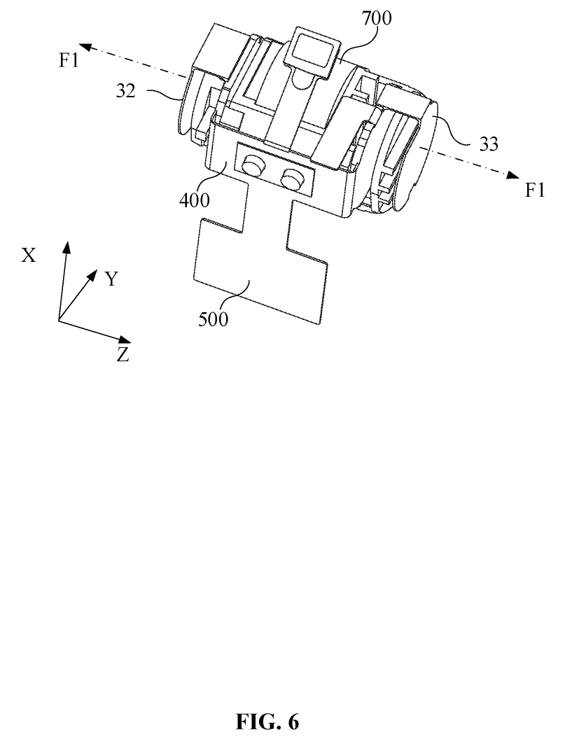

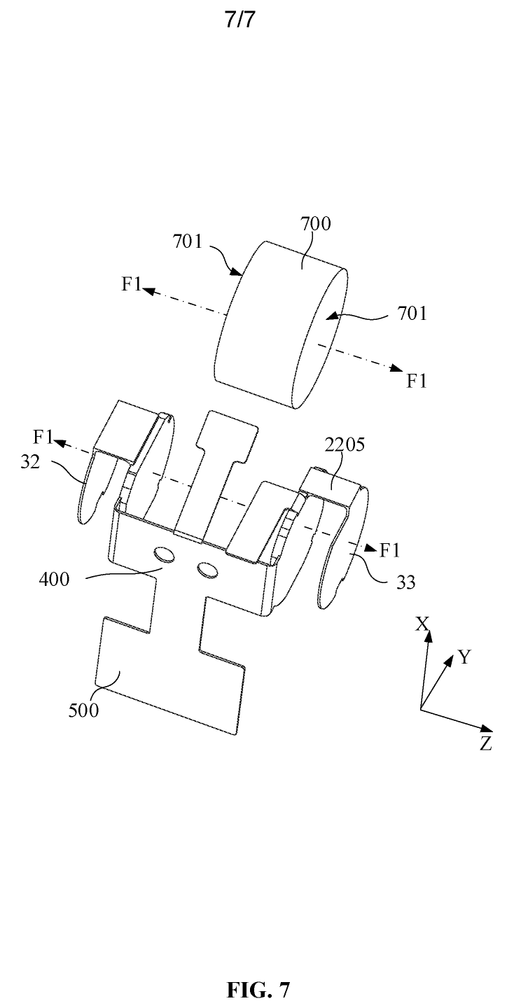

Optionally, as shown in FIGS. 6 and 7, the earphone 1 further includes a battery 700 disposed in the first housing 31. The battery 700 is arranged in a column shape, e.g., a square column with a square or rectangular bottom surface, or a cylinder with a circular bottom surface, etc. An axial direction F1 of the battery 700 is defined as an extension direction perpendicular to a bottom surface of the columnar. For example, in some embodiments, the battery 700 is arranged as a cylinder, and the axial direction F1 of the battery 700 is defined as the extension direction perpendicular to an end face 701 of the battery 700.

Optionally, as shown in FIGS. 6 and 7, the first touch detection element 32 and the second touch detection element 33 are respectively arranged in a sheet-shape, and are spaced apart along the axial direction F1 of the battery 700 and disposed at two ends of the battery 700. Such arrangement can effectively improve the space utilization inside the first housing 31, improve the structural integration and compactness of the earphone 1, and also effectively reduce interference from the battery 700 to the first touch detection element 32 and the second touch detection element 33, thereby improving the performance of the first touch detection element 32 and the second touch detection element 33, and effectively improving the accuracy of touch detection on the earphone. Furthermore, at least a portion of a projection of the first touch detection element 32 along the axial direction F1 of the battery 700 and at least a portion of a projection of the second touch detection element 33 along the axial direction F1 of the battery 700 overlap with the end face 701 of the battery 700, respectively. Such an arrangement can effectively reduce the space occupation of the first touch detection element 32 and the second touch detection element 33 in the radial direction of the battery 700, thereby effectively improving the space utilization inside the first housing 31. Optionally, the first touch region 301 and the second touch region 302 are respectively arranged opposite to the first touch detection element 32 and the second touch detection element 33, i.e., the first touch region 301 and the second touch region 302 are spaced apart along the axial direction F1 of the battery 700 on the first housing 31.

Optionally, a ratio of an overlapping area between the first touch detection element 32 and the end face 701 of the battery 700 to an area of a main surface of the first touch detection element 32 is greater than or equal to 0.9, for example, it may be 0.92, 0.95, 0.98, etc., and of course, it may also be other values. A ratio of an overlapping area between the second touch detection element 33 and the end face 701 of the battery 700 to an area of a main surface of the second touch detection element 33 is greater than or equal to 0.9, for example, it may be 0.92, 0.95, 0.98, etc., and of course, it may also be other values. The overlapping area between the first touch detection element 32 and the end face 701 of the battery 700 is the overlapping area between the projection of the first touch detection element 32 along the axial direction F1 of the battery 700 and the end face 701 of the battery 700. Correspondingly, the overlapping area between the second touch detection element 33 and the end face 701 of the battery 700 is the overlapping area between the projection of the second touch detection element 33 along the axial direction F1 of the battery 700 and the end face 701 of the battery 700. This setting manner can effectively reduce the space occupation of the first touch detection element 32 and the second touch detection element 33 along the radial direction of the battery 700, thereby effectively improving the space utilization among the first touch detection element 32, the second touch detection element 33, and the battery 700. Preferably, in some embodiments, the overlapping area between the first touch detection element 32 and the end face 701 of the battery 700 may be equal to a total projection area of the first touch detection element 32 along the axial direction F1 of the battery 700, that is, a ratio of the overlapping area between the first touch detection element 32 and the end face 701 of the battery 700 to the total projection area of the first touch detection element 32 along the axial direction F1 of the battery 700 is equal to 1. The overlapping area between the second touch detection element 33 and the end face 701 of the battery 700 may be equal to a total projection area of the second touch detection element 33 along the axial direction F1 of the battery 700, that is, a ratio of the overlapping area between the second touch detection element 33 and the end face 701 of the battery 700 to the total projection area of the second touch detection element 33 along the axial direction F1 of the battery 700 is equal to 1.

Furthermore, as shown in FIGS. 6 and 7, an angle between a normal direction of the main surface of the first touch detection element 32 and the axial direction F1 of the battery 700 and an angle between a normal direction of the main surface of the second touch detection element 33 and the axial direction F1 of the battery 700 are respectively less than or equal to 10°, for example, they may be 3°, 5°, 8°, etc., and of course, they may also be other values. Such an arrangement can make the main surface of the first touch detection element 32 and the main surface of the second touch detection element 33 as parallel as possible to the adjacent end face 701 of the battery 700, thereby further improving the space utilization among the battery 700, the first touch detection element 32, and the second touch detection element 33. For example, in some embodiments, an angle between the normal direction of the main surface of the first touch detection element 32 and the axial direction F1 of the battery 700 and an angle between the normal direction of the main surface of the second touch detection element 33 and the axial direction F1 of the battery 700 may be set to 0°.

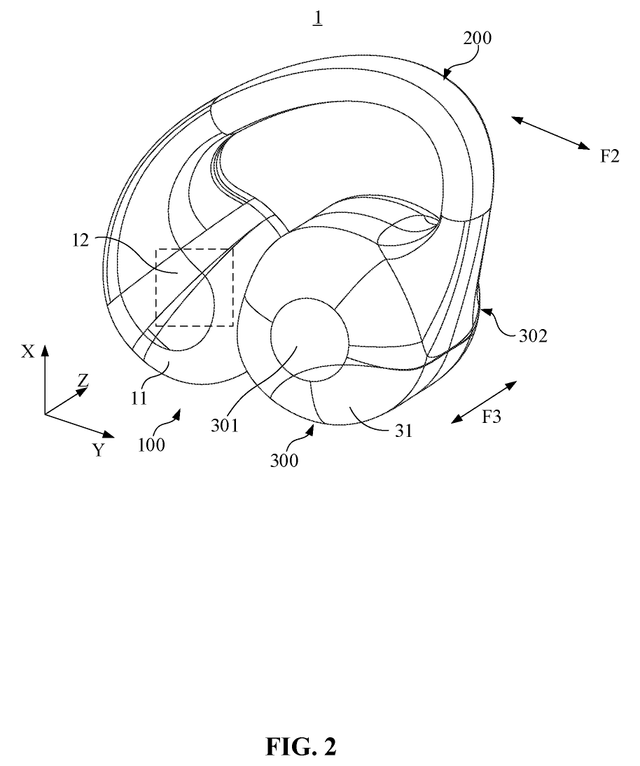

Optionally, as shown in FIGS. 2 and 3, the earphone 1 further includes a second housing 11, the connecting component 200, and a sounding assembly 12. Optionally, the earphone 1 includes a sound generating component 100. The sound generating component 100 includes the second housing 11, the sounding assembly 12 is disposed in the second housing 11, and the sounding assembly 12 is configured to generate sound under the control of the processing circuit 400 and transmit it outward from the second housing 11. The connecting component 200 connects the first housing 31 and the second housing 11 to achieve the connection between the abutting component 300 and the sound generating component 100. In the wearing state, the first housing 31 and the second housing 11 form a clamping fit on two sides of the helix E17, and the second housing 11 is located in the cavum concha E12, the connecting component 200 has a symmetry plane SF arranged along a length direction F2 of the connecting component 200, and the axial direction F1 of the battery 700 is arranged to intersect with the symmetry plane SF, which effectively improves the wearing comfort of the earphone 1 while facilitating the user to operate and touch the earphone 1.

The symmetry plane SF of the connecting component 200 refers to a plane arranged along the length direction F2 of the connecting component 200, and the parts of the connecting component 200 on both sides of the symmetry plane SF have a minimal or consistent difference, that is, if the connecting component 200 is regularly symmetrical, then the parts of the connecting component 200 on both sides of the symmetry plane SF are consistent; if the connecting component 200 is not strictly symmetrical, then the difference between the parts of the connecting component 200 on both sides of the symmetry plane SF should be the smallest among various division manners, for example, the projection of the connecting component 200 may be observed on a plane perpendicular to the symmetry plane SF to distinguish the difference.

Furthermore, as shown in FIG. 3, the earphone 1 is configured as a symmetrical structure (at least referring to an overall appearance contour of the earphone 1) symmetrical with respect to the symmetry plane SF of the connecting component 200. Based on the arrangement, the earphone 1 can simultaneously adapt to wearing on the left ear and the right ear, and the earphone 1 can ensure good wearing comfort when worn on the left ear or the right ear.

Optionally, as shown in FIG. 1, in the embodiment, the earphone 1 is an ear-clip earphone 1, the symmetry plane SF intersects with the sagittal plane of the user, and an angle between the symmetry plane SF and the sagittal plane is greater than or equal to 72° and less than or equal to 90°, for example, it may be 75°, 80°, 85°, etc., and of course, it may also be other values. Such arrangement can effectively ensure that in the wearing state, the axial direction F1 of the battery 700 can be arranged to intersect with the horizontal plane of the human body, so that the user can conveniently and freely perform touch operations on the first touch region 301 and the second touch region 302, effectively improving the convenience of touch operations and enhancing the comfort of using the earphone 1.

The above are only embodiments of the present disclosure, and do not limit the patent scope of the present disclosure. Any equivalent structure or equivalent process transformation made by using the content of the description and drawings of the present disclosure, or direct or indirect application in other related technical fields, shall be similarly included within the patent protection scope of the present disclosure.

What is claimed is:

1. An earphone, comprising: a first housing, a first touch detection element, a second touch detection element, and a processing circuit, wherein
the first housing carries the first touch detection element and the second touch detection element, and has a first touch region and a second touch region that are spaced apart from each other and arranged back-to-back in orientation, wherein in a wearing state of the earphone, the first housing is located on a back side of a helix of a user;
the first touch detection element is configured to generate a first touch indication signal in response to a capacitance change caused by a touch operation of the user on the first touch region;
the second touch detection element is configured to generate a second touch indication signal in response to a capacitance change caused by a touch operation of the user on the second touch region; and
the processing circuit is configured to generate a control instruction based on the first touch indication signal, the second touch indication signal, and a preset instruction generation logic.

2. The earphone according to claim 1, wherein in a wearing state of the earphone, a spacing direction between the first touch region and the second touch region is arranged to intersect with a horizontal plane of the user.

3. The earphone according to claim 1, wherein the preset instruction generation logic is configured to generate a first control instruction in response to the first touch indication signal and the second touch indication signal, respectively indicating that the user is continuously contacting the first touch region and the second touch region.

4. The earphone according to claim 1, wherein the preset instruction generation logic is configured to generate a second control instruction in response to the first touch indication signal indicating that the user continuously contacts the first touch region, while the second touch indication signal indicates that the user is tapping the second touch region.

5. The earphone according to claim 1, wherein the preset instruction generation logic is configured to generate a third control instruction in response to the first touch indication signal and the second touch indication signal, respectively indicating that the user is tapping the first touch region and tapping the second touch region.

6. The earphone according to claim 1, wherein
the processing circuit is configured to generate the control instruction based on the preset instruction generation logic when confirming that the first touch indication signal and the second touch indication signal are greater than a first threshold and a second threshold, respectively.

7. The earphone according to claim 1, further comprising:
a wearing detection element configured to detect whether the earphone is in the wearing state or a non-wearing state, wherein
the processing circuit is configured to select different preset instruction generation logics when the earphone is in the wearing state or the non-wearing state, such that identical first touch indication signals and identical second touch indication signals produce different control signals through the different preset instruction generation logics.

8. The earphone according to claim 1, further comprising:
a left-right ear detection element configured to detect whether the earphone is worn on a left ear or a right ear, wherein
the processing circuit is configured to select different preset instruction generation logics when the earphone is worn on the left ear or the right ear, such that identical first touch indication signals and identical second touch indication signals produce different control signals through the different preset instruction generation logics.

9. The earphone according to claim 8, wherein the left-right ear detection element is a gravity sensor, wherein
the earphone further includes a wearing detection element configured to detect whether the earphone is in a wearing state or a non-wearing state, and
the processing circuit is configured to trigger a detection function of the left-right ear detection element when the earphone is in the wearing state.

10. The earphone according to claim 1, wherein
the earphone further includes a battery disposed in the first housing, the battery being arranged in a column shape,
the first touch detection element and the second touch detection element are respectively arranged in a sheet-shape, and
the first touch detection element and the second touch detection element are spaced apart along an axial direction of the battery and disposed at two ends of the battery.

11. The earphone according to claim 10, wherein at least a portion of a projection of the first touch detection element along the axial direction of the battery and at least a portion of a projection of the second touch detection element along the axial direction of the battery overlap with an end face of the battery, respectively.

12. The earphone according to claim 11, wherein
a ratio of an overlapping area between the first touch detection element and the end face of the battery to an area of a main surface of the first touch detection element is greater than or equal to 0.9; and
a ratio of an overlapping area between the second touch detection element and the end face of the battery to an area of a main surface of the second touch detection element is greater than or equal to 0.9.

13. The earphone according to claim 12, wherein
the overlapping area between the first touch detection element and the end face of the battery is equal to a total projection area of the first touch detection element along the axial direction of the battery; and
the overlapping area between the second touch detection element and the end face of the battery is equal to a total projection area of the second touch detection element along the axial direction of the battery.

14. The earphone according to claim 12, wherein
an angle between a normal direction of the main surface of the first touch detection element and the axial direction of the battery is less than or equal to 10°, and
an angle between a normal direction of the main surface of the second touch detection element and the axial direction of the battery is less than or equal to 10°.

15. The earphone according to claim 12, wherein
an angle between a normal direction of the main surface of the first touch detection element and the axial direction of the battery is less than or equal to 3°, and
an angle between a normal direction of the main surface of the second touch detection element and the axial direction of the battery is less than or equal to 3°.

16. The earphone according to claim 14, further comprising: a second housing, a connecting component, and a sounding assembly, wherein
the sounding assembly is disposed in the second housing,
the connecting component connects the first housing and the second housing,
in a wearing state of the earphone, the first housing and the second housing form a clamping fit on two sides of the helix, and
the second housing is located in a cavum concha.

17. The earphone according to claim 16, wherein
the connecting component has a symmetry plane arranged along a length direction of the connecting component, and
the axial direction of the battery is arranged to intersect with the symmetry plane.

18. The earphone according to claim 17, wherein
the earphone is configured as a symmetrical structure symmetrical with respect to the symmetry plane of the connecting component.

19. The earphone according to claim 17, wherein
the symmetry plane intersects with a sagittal plane of the user, and
an angle between the symmetry plane and the sagittal plane is greater than or equal to 72° and less than or equal to 90°.

20. The earphone according to claim 19, wherein the angle between the symmetry plane and the sagittal plane is greater than or equal to 80° and less than or equal to 90°.
